(19) United States
(12) Patent Application Publication
(10) Pub. No.: US 2010/0242590 A1
(43) Pub. Date: Sep. 30, 2010

(54) Flow Meter and Temperature Stabilizing Cover Therefor

(75) Inventor: Donald Merlyn Day, Cypress, TX (US)

Correspondence Address: CONLEY ROSE, P.C.;David A. Rose, P. O. BOX 3267, HOUSTON, TX, 77253-3267, US

(73) Assignee: Daniel Measurement and Control, Inc., Houston, TX (US)

(21) Appl. No.: 12/413,079

(22) Filed: Mar. 27, 2009

(51) Int. Cl. G01F 1/684

(52) U.S. Cl. 73/204.22

(57) ABSTRACT

A flow meter and a temperature stabilizing cover for tie flow meter are disclosed. In some embodiments, the flow meter includes a spool member having a throughbore for fluids to pass therethrough, one or more transducers extending into the throughbore, and a cover disposed about the spool member and the one or more transducers. The cover includes a plurality of cover pieces fastened together. The cover pieces are formed of layers including an insulation layer, a radiant barrier, and an outer shell. The outer shell includes a material having a rigidity exceeding that of the insulation layer and that of the radiant barrier.

### BACKGROUND

This disclosure relates generally to flow meters for measuring fluid flow rates through pipes or other conduits. More particularly, the disclosure relates to a temperature stabilizing cover for such flow meters.

After hydrocarbons have been removed from the ground, the fluid stream (such as crude or natural gas) is transported from place to place via pipelines. It is desirable to know with accuracy the amount of fluid flowing in the stream. Particular accuracy is demanded when the fluid is changing hands, known as “custody transfer.”

Flow meters may be used to measure fluid flow rates through a pipeline. One type of flow meter widely used is an ultrasonic flow meter. In an ultrasonic flow meter, acoustic signals are sent back and forth across the fluid stream to be measured between one or more pairs of transducers. Each pair of transducers is positioned within the spool piece, or body, such that an acoustic signal traveling from one transducer to the other intersects fluid flowing through the meter at an angle. Electronics coupled to the meter measure the difference between the transit time required for an acoustic signal to travel from the downstream transducer to the upstream transducer, and the transit time required for an acoustic signal to travel from the upstream transducer to the downstream transducer. The flow rate of fluid passing through the meter is then calculated as a function of the difference in the transit times and the path, or chord, length between faces of the transducers.

Temperature changes in the meter add complexity to the flow rate calculations. Each transducer is positioned within a housing, which is, in turn, coupled to the spool piece. Often the transducer housings and the spool piece have dissimilar materials. For example, the spool piece is typically made of carbon steel, while the transducer housings are made from stainless steel. Dissimilar materials, such as these, usually have different coefficients of expansion. Thus, when exposed to heat, the spool piece and the transducer housings experience unequal elongation, and when exposed to cold environments, contract to different degrees. During operation, the meter is usually exposed to transient ambient conditions, and the temperature of the spool piece and the transducer housings are subject to change. Consequently, the spool piece and transducer housings elongate and contract to different degrees, causing the transducer housings, and thus the transducers, to shift slightly relative to their installed positions. Such movement, in turn, causes the chord length between pairs of transducers to change. The change in the chord lengths from their installed values introduces inaccuracy to the calculated flow rate of fluid passing through the meter.

To compensate for this shifting of the transducers, a correction factor is typically applied during flow rate calculations in accordance with American Petroleum Institute (API) standards. Even so, the application of the correction factor also introduces uncertainty to the flow rate calculations. Given the magnitude of product flowing through ultrasonic flow meters, even small inaccuracies in rate calculation can lead to significant errors in flow rate estimation, and in the case of custody change, significant levels of lost revenue.

Accordingly, there remains a need in the art for apparatus and methods that enable greater accuracy of product flow rate estimations through ultrasonic flow meters.

### SUMMARY

The disclosure includes a flow meter and a temperature stabilizing cover for the flow meter. In some embodiments, the flow meter includes a spool member having a throughbore for fluids to pass therethrough, one or more transducers extending into the throughbore, and a cover disposed about the spool member and the one or more transducers. The cover includes a plurality of cover pieces fastened together. The cover pieces are formed of layers that, in certain embodiments, include an insulation layer, a radiant barrier, and an outer shell. The outer shell includes a material having a rigidity exceeding that of the insulation layer and that of the radiant barrier. In some embodiments, the cover pieces are formed of layers including an insulation layer disposed between two radiant barriers and an outer shell disposed radially outward of the insulation layer and radiant barriers.

In some embodiments, a cover for a flow meter includes a plurality of cover components fastened together. The cover components have a predetermined shape before being fastened together and generally retain that predetermined shape upon being fastened together. Also, the cover components include a plurality of material layers having different thermal properties.

Some methods for temperature stabilization of a flow meter exposed to an environment characterized by transient thermal conditions include disposing a layer of insulation around at least a portion of the ultrasonic flow meter, positioning a first radiant barrier radially outward of the insulation layer to reduce radiative heat transfer from the environment to the insulation layer, positioning a second radiant barrier radially inward of the insulation layer to reduce radiative heat transfer from the ultrasonic flow meter to the insulation layer, enclosing the first radiant barrier, the insulation layer, and the second radiant barrier between an outer shell and an inner shell to form a cover, and maintaining a defined temperature difference through a spool piece of the ultrasonic flow meter and the cover below a maximum limit.

Thus, the embodiments of the disclosure comprise a combination of features and advantages that promote temperature stabilization of ultrasonic flow meters. These and various other characteristics and advantages of the disclosure will be readily apparent to those skilled in the art upon reading the following detailed description and by referring to the accompanying drawings.

### BRIEF DESCRIPTION OF THE DRAWINGS

For a more detailed understanding, reference is made to the accompanying Figures, wherein:

FIG. 1 is a perspective view of an embodiment of a flow meter and temperature stabilization cover in accordance with the principles disclosed herein;

FIG. 2 is an exploded, perspective view of the cover and flow meter of FIG. 1;

FIGS. 3A and 3B are side and cross-sectional end views of the cover and flow meter of FIG. 1;

FIG. 4 is a partial cross-sectional, schematic view of the temperature stabilizing cover and meter of FIG. 3, illustrating the dominant mode of heat transfer through each;

FIG. 5 is a perspective view of another embodiment of a flow meter and temperature stabilization cover in accordance with the principles disclosed herein;

FIG. 6 is an exploded, perspective view of the cover and flow meter of FIG. 5; and

FIGS. 7A and 7B are side and cross-sectional end views of the cover and flow meter of FIG. 5.

### DETAILED DESCRIPTION OF PREFERRED EMBODIMENTS

In the drawings and description that follow, like parts are typically marked throughout the specification and drawings with the same reference numerals, respectively. The drawing figures are not necessarily to scale. Certain features of the invention may be shown exaggerated in scale or in somewhat schematic form, and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results.

Unless otherwise specified, any use of any form of the terms “connect”, “engage”, “couple”, “attach”, or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. The various characteristics mentioned above, as well as other features and characteristics described in more detail below, will be readily apparent to those skilled in the art upon reading the following detailed description of the embodiments, and by referring to the accompanying drawings.

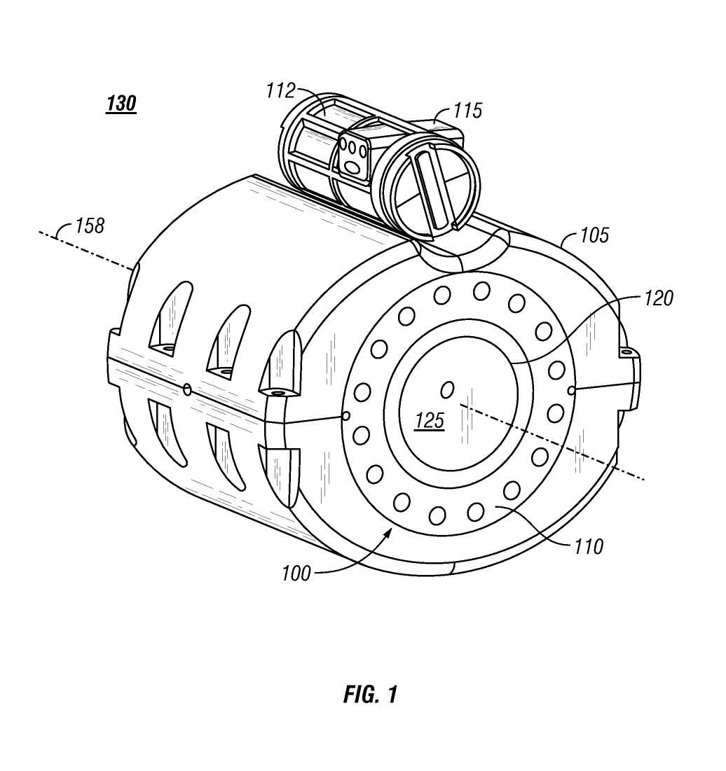

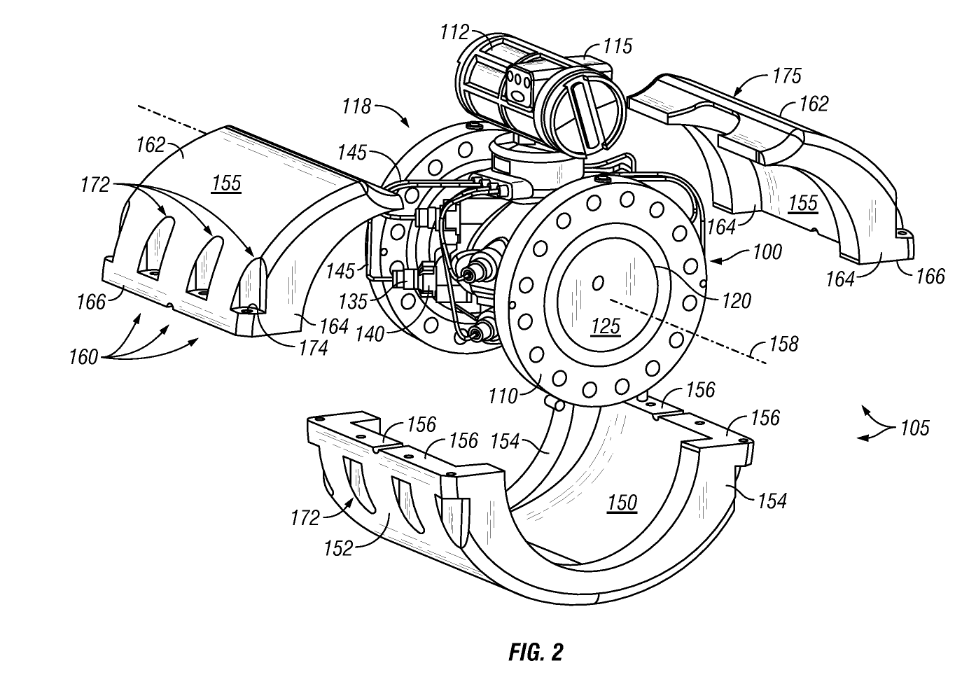

Referring now to FIG. 1, a perspective view of an ultrasonic flow meter 100 disposed within a temperature stabilizing cover 105 in accordance with the principles disclosed herein is shown. Meter 100 includes a spool piece 110 extending longitudinally or axially within cover 105. An enclosure 112 housing electronics 115 is mounted on the top of spool piece 110. Spool piece 110 is a housing within which one or more pairs of transducers (FIG. 2) are mounted. Spool piece 110 includes an inlet 118 (not visible in this view), an outlet 120, and a longitudinal flowbore 125 extending therebetween. Fluid or product passes through meter 100 by way of flowbore 125. Meter 100 is configured to allow calculation of the flow rate of product passing therethrough. As described above, acoustic signals are transmitted through the flowing product and received between each pair of transducers. Electronics 115 provide power to the transducers and receive signals from the transducers via cables 145 (FIG. 2) coupled therebetween. Upon receipt of the signals from the transducers, electronics 115 processes the signals to determine the flow rate of product passing through flowbore 125 of meter 100.

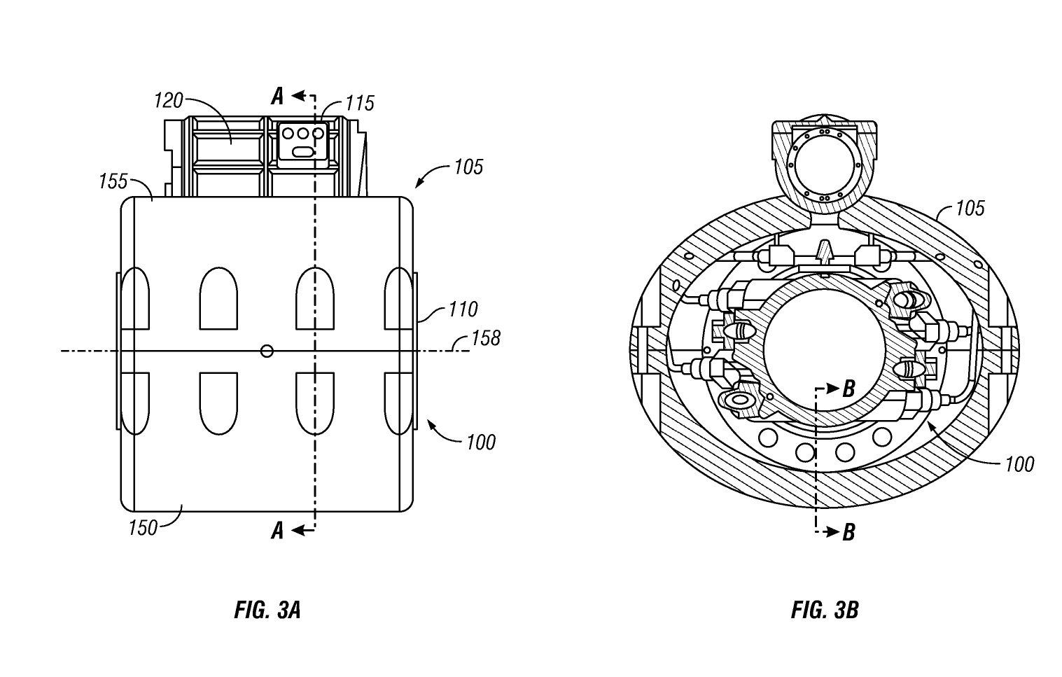

Temperature stabilizing cover 105 extends around the periphery of spool piece 110, leaving open inlet 118 and outlet 120 to allow product to pass through meter 100 within flowbore 125. Further, cover 105 is supported by spool piece 110, and essentially suspends from spool piece 110, as best viewed in FIG. 3B. As will be described, cover 105 is a multi-layer or composite structure configured to limit the rate of heat transfer between product passing through meter 100 and the environment 130 external to cover 105. By limiting the rate of heat exchange between the product and the surrounding environment 130, temperature changes arising from transient changes in the environmental temperature and otherwise experienced by meter 100, and in particular spool piece 105 and housings that support the transducers mounted therein, are limited. By limiting such heat exchange rates, shifting of the transducers in response to temperature changes is reduced, as compared to that experienced in the absence of cover 105, potentially reducing the need for the application of a correction factor, such as those recommended by API standards, during calculations of the product flow rate through meter 100. Lessening the reliance on use of the correction factor to the flow rate calculation methodology reduces the level of uncertainty in the flow rate estimates and enhances calculation accuracy.

Turning to FIG. 2, an exploded view of temperature stabilizing cover 105 is shown with meter 100 positioned therein. With cover 105 shown disassembled, a plurality of transducers 135, each disposed within a housing 140 mounted within spool piece 110, are now visible. Further, cables 145 are coupled between electronics 115 and transducers 135, conveying electrical power and carrying signals between transducers 135 and electronics 115, are also visible.

In this embodiment, cover 105 includes three separate pieces, a lower half piece 150 and two upper quarter pieces 155. A plurality of fasteners or coupling means 160 are employed to lock pieces 150, 155 together to form a complete cover 105, as shown in FIG. 1. When disengaged, coupling means 160 allow disassembly of cover 105 and separation of each piece 150, 155 from the others 150, 155, as shown in FIG. 2. Each of pieces 150, 155 have a predetermined shape before fastening by coupling means 160 and generally retain that shape once locked together. That is, cover pieces 150, 155 are generally rigid enough such that their shape does not change upon being connected or coupled together to form complete cover 105. Although cover 105 is formed from three pieces 150, 155 in this embodiment, cover 105 may in other embodiments include fewer or more pieces, all of which, when assembled, form a similar enclosure about spool piece 110.

Lower half piece 150 includes a central portion 152 extending between two semicircular ends or rim portions 154. Collectively, portion 152 and portions 154 terminate in substantially planar flanges 156. Ends 154 extend substantially 180° around spool piece 110 and its longitudinal axis 158. In this manner, lower half piece 150 may be said to half-circumscribe spool piece 110.

Similarly, each of upper quarter pieces 155 includes a central portion 162 disposed between two curved rims or end portions 164. End portions 164 extend substantially 90° about spool piece 110 and longitudinal axis 158. Collectively, central portion 162 and ends 164 terminate to form a generally planar flange 166. When assembled about spool piece 100 to form cover 105, flanges 156 of lower half piece 150 mate with and are attached to flanges 166 of upper quarter pieces 155 by coupling means 160. Each of pieces 155 further include a semi-circular opening 175 formed therein. When pieces 150, 155 are assembled about meter 100, as shown in FIG. 1, openings 175 receive electronics 115 to allow cover 105 to enclose spool piece 110 but not electronics 115, which remain exposed to the surrounding environment 130.

In the embodiment shown, the outer surfaces of pieces 150, 155 include partial or counter bores 172 forming seats 174. Coupling means 160 are positioned on seats 174 to couple upper quarter pieces 155 to lower half pieces 150. In some embodiments, including that illustrated by FIGS. 1 through 3B, coupling means 160 includes a bolt (not shown) insertable through each pair of aligned bores 172 and a nut (also not shown) which threadably engages each bolt. In other embodiments, coupling means 160 may include a releasable latch, spring clips, or other fasteners.

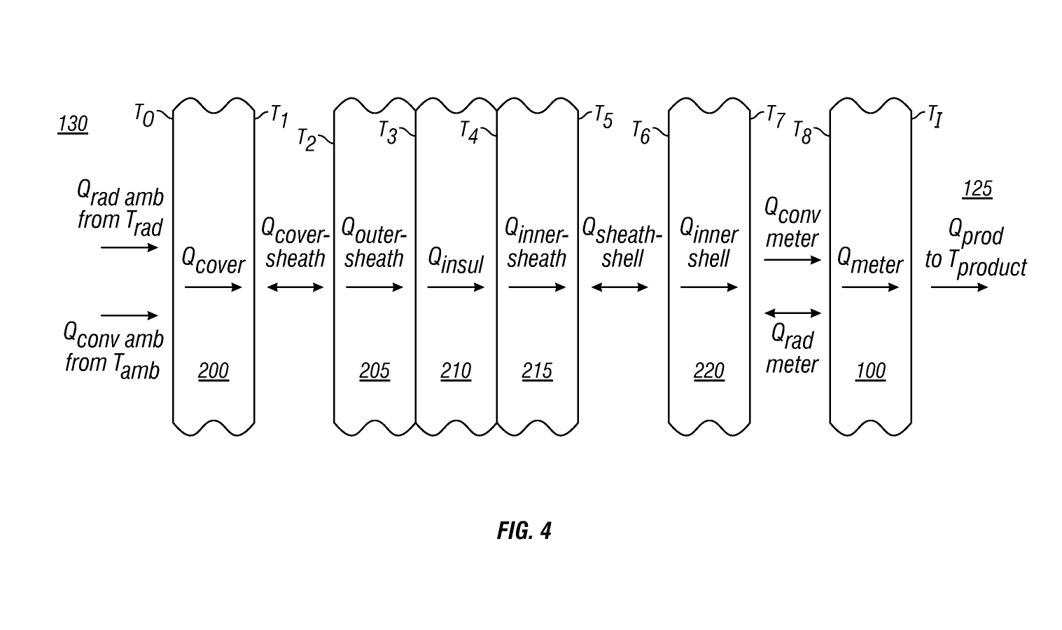

FIG. 3A shows a side, elevation view of pieces 150, 155 of cover 105 assembled and locked about meter 100. A Section A-A through cover 105 and meter 100 is identified in FIG. 3A and illustrated in FIG. 3B. As best shown in FIG. 3B, cover 105 forms a chamber that is generally elliptical in shape when viewed in cross-section and normal to spool axis 158. For the sake of simplicity, the composite or multi-layered nature of cover 105 is not fully illustrated in FIG. 3B. However, cover 105 is a multi-layer structure, as best illustrated by FIG. 4.

Turning to FIG. 4, proceeding from the outermost layer exposed to the environment 130 radially inward toward flowbore 125 of meter 100, each piece 150, 155 of cover 105 includes outer shell 200, an outer sheath 205, an insulation layer 210, an inner sheath 215, and an inner shell 220. Outer shell 200 is a rigid material layer which protects the remaining layers 205, 210, 215, 220 from the surrounding environment 130, such as from direct exposure to rain, snow, and ultraviolet light. In some embodiments, outer shell 200 is substantially impermeable to moisture. The rigidity of outer shell 200 exceeds the rigidity of insulation layer 210 and sheaths 205, 215, and enables outer shell 200 to retain its installed shape when impacted by rain, ice, and debris stirred up by wind or incidental bumps experienced, for example, during maintenance operations. In some embodiments, outer shell 200 is made of plastic and/or is capable of withstanding impact loads of six pounds per square inch of surface area. The shape of outer shell 200 is shaped to receive spool piece 110 of meter 100 therein with sufficient clearance therebetween to enable positioning of outer sheath 205, insulation layer 210, inner sheath 215, and inner shell 220 between outer shell 200 and spool piece 110. In some embodiments, outer shell 200 is elliptically shaped, as shown in FIG. 3B, or may be cylindrically shaped.

Outer sheath 205 is radially inward of outer shell 200. Outer sheath 205 is a radiant barrier configured to retard radiative heat transfer from the environment 130 to meter 100. As such, outer sheath 205 is formed of a material having high reflectivity, such as but not limited to mylar. Preferably, outer sheath 205 includes a material having a reflectivity in the range 0.7 to 0.90. In some embodiments, outer sheath 205 is formed as a thin plastic or metal skin. Insulation 210 is disposed radially inward of outer sheath 205, and is configured to retard the transfer of heat by conduction between outer sheath 205 and inner sheath 210. In some embodiments, insulation 210 is a foam poured or injected between inner and outer sheaths 215, 205, which acts on and forces sheaths 205, 215 into contact with the outer and inner shells 200, 220, respectively. Inner sheath 215, which is radially inward of insulation 210, is also a radiant barrier. However, inner sheath 215 is configured to retard radiative heat transfer from meter 100 to the environment 130. Like outer sheath 205, inner sheath 215 is formed of a material having high reflectivity, such as but not limited to mylar. Preferably, inner sheath 215 includes a material having a reflectivity in the range 0.7 to 0.9. Moreover, in some embodiments, the material properties and thicknesses of sheaths 205, 215 are substantially the same.

Finally, the radially innermost layer of cover 105 is inner shell 220. Inner shell 220 is configured to receive spool piece 110 of meter 100 therein and to protect the remaining outer layers 215, 210, 205, 200 from degrading due to movement of meter 100 during operation. Inner shell 220 also prevents the migration of moisture toward meter 100, which when exposed to moisture over a prolonged period of time, can cause corrosion of meter 100, including spool piece 110 and other metallic components mounted therein. In some embodiments, inner shell 220 is made of plastic. Inner shell 220 is coupled to outer shell 200 with sheaths 205, 215 and insulation 210 disposed therebetween by a plurality of fasteners, such as but not limited to threaded bolts and/or screws, each secured by a nut. Alternatively, or in addition to the fasteners, adhesives may be employed between adjacent layers.

As illustrated by FIG. 4, during operation of meter 100 in an environment 130 having an ambient temperature T_{amb} and a radiant temperature T_{rad} in excess of the temperature of product T_{product} flowing through meter 100, heat is transferred from the environment 130 to meter 100 by various modes. When T_{product} exceeds T_{amb} and T_{rad}, heat is transferred in the opposite direction, meaning from meter 100 to the environment 130, by the same modes. Even so, the following discussion and methodology is applicable to both scenarios.

For reasons described above, cover 105 is intended to provide temperature stabilization of meter 100 during operation. Temperature stabilization of meter 100 occurs when the temperature difference between the outer surface of cover 200 and the inner surface of meter 100, T_{O}−T_{I}, is less than a predetermined value, which, in at least some embodiments, is 100° F. In other embodiments, the predetermined value, or limit, may be a function of T_{product}, which, given typical product flow rates through meter 100, is quite close in value to T_{I}. The predetermined value, or limit, may also be a function of an equivalent environmental temperature, which is dependent upon both T_{amb} and T_{rad}. The following paragraphs describe a methodology of providing cover 105 for a given set of environmental conditions T_{amb}, T_{rad} and product temperature T_{product}.

Referring still to FIG. 4, heat is transferred from the environment 130 to cover 200 by two primary modes, through radiation Q_{rad amb} and forced convection Q_{conv amb}. Q_{rad amb} is a function of: T_{rad}, the outer surface temperature of cover 200 T_{O}, and the emissivity of cover 200. Q_{conv amb} is a function of: T_{amb}, T_{O}, and a convective heat transfer or film coefficient, which is dependent upon air velocity around cover 200 and can be calculated using methods well known in the industry. Heat transferred to cover 200 by these modes is then conducted through cover 200. The rate of heat conducted through cover 200, Q_{cover}, is dependent upon the thickness of cover 200, its thermal conductivity, and the temperature drop across cover 200, T_{O}−T₁, where T₁ is the inner surface temperature of cover 200.

The dominant mode of heat transfer between cover 200 and outer sheath 205 is radiation. The rate of radiative heat exchanged between cover 200 and outer sheath 205, Q_{cover-sheath}, is a function of: the emissivity of cover 200, the emissivity of outer sheath 205, and the temperatures of their adjacent surfaces, T₁ and T₂.

Heat transferred to outer sheath 205 by radiation is then conducted through outer sheath 205, insulation 210, and inner sheath 215. The rate of heat conducted through outer sheath 205, Q_{outer sheath}, through insulation 210, Qᵢₙₛᵤₗ, and through inner sheath 215, Q_{inner sheath}, is dependent upon the respective thickness and thermal conductivity of each layer, as well as the temperature drop across the layer. The temperature drops across outer sheath 205, insulation 210, and inner sheath 215 are T₂-T₃, T₃-T₄, and T₄-T₅, respectively, where T₃, T₄, and T₅ are temperatures at the inner surfaces of outer sheath 205, insulation 210, and inner sheath 215.

The dominant mode of heat transfer between inner sheath 215 and inner shell 220 is radiation. The rate of radiative heat exchanged between inner sheath 215 and inner shell 220, Qₛₕₑₐₜₕ₋ₛₕₑₗₗ, is a function of the emissivity of inner sheath 215, the emissivity of inner shell 220, and the temperatures of their adjacent surfaces, T₅ and T₆.

Heat transferred to inner shell 220 by radiation is then conducted through inner shell 220. The rate of heat conducted through inner shell 220, Q_{inner shell}, is dependent upon the thickness of inner shell 220, its thermal conductivity, and the temperature drop across inner shell 220, T₆-T₇, where T₆ and T₇ are the outer and inner surface temperatures of inner shell 220, respectively,

Heat is transferred from inner shell 220 to meter 100 by radiation Q_{rad meter} and natural convection Q_{conv meter}. The rate of radiative heat exchanged between inner shell 220 and meter 100, Q_{rad meter}, is a function of the emissivity of inner shell 220, the emissivity of meter 100, and the temperatures of their adjacent surfaces, T₇ and T₈. Q_{conv meter} is a function of a natural convection heat transfer or film coefficient, which can be calculated using methods well known in the industry, and surface temperatures T₇ and T₈. Given the location of Section B-B, illustrated in FIG. 3B, the properties of meter 100 are approximated by those of spool piece 110.

Heat transferred to meter 100 by these modes is then conducted through meter 100. The rate of heat conducted Qₘₑₜₑᵣ through meter 100 is dependent upon the thickness of meter 100, its thermal conductivity, and the difference between its outer and inner surface temperatures, T₈ and T_{O}. Heat conducted through meter 100 is then transferred to product flowing through meter 100 by forced convection. The rate of heat transferred to the product by convection, Q_{prod}, is a function of T₈, T_{product}, and a forced convection heat transfer or film coefficient, which again is calculated by methods well known in the industry.

To provide cover 105 such that it provides temperature stabilization of meter 100, an initial configuration of cover 105 is first defined by specifying a type of material for each layer, e.g., mylar for outer sheath 205, and an associated thickness. Material dependent properties, such as thermal conductivity and emissivity, may then be defined. A heat balance is next performed at each surface of cover 200, outer sheath 205, insulation 210, inner sheath 215, inner shell 220, and meter 100, accounting for the above-described sources of heat transfer. In some embodiments, steady-state, one-dimensional heat transfer is assumed through and between cover 105 and meter 100. In any event, the heat balance equations yield a system of equations in terms of unknown surface temperatures T₁, T₂, . . . , T₈ and other defined or known parameters, such as material properties, thicknesses, T_{rad}, T_{amb}, and T_{product}. This system of equations is then solved using computational methods, which too are well known in the industry, for surface temperatures T₁, T₂, . . . , T₈. Using the temperature solution, the temperature drop across cover 105 and meter 100, T_{O}−T_{I}, is then evaluated.

In the event that the temperature difference T_{O}−T_{I} exceeds the predetermined criteria for temperature stabilization of meter 100, e.g., 100° F., the assumed configuration of cover 105 is then modified by increasing the material thickness and/or changing the type of material for any one or more of the layers of cover 105. Once a modified configuration of cover 105 is defined, heat balance equations are again developed and subsequently solved to determine surface temperatures T₁, T₂, . . . , T₈. Again, the temperature difference T_{O}−T_{I} is evaluated. This process is repeated until a design configuration for cover 105 is identified which provides a maximum temperature drop through cover 105 and meter 100 of no greater than 100° F. for the defined values of T_{product}, T_{amb}, and T_{rad}.

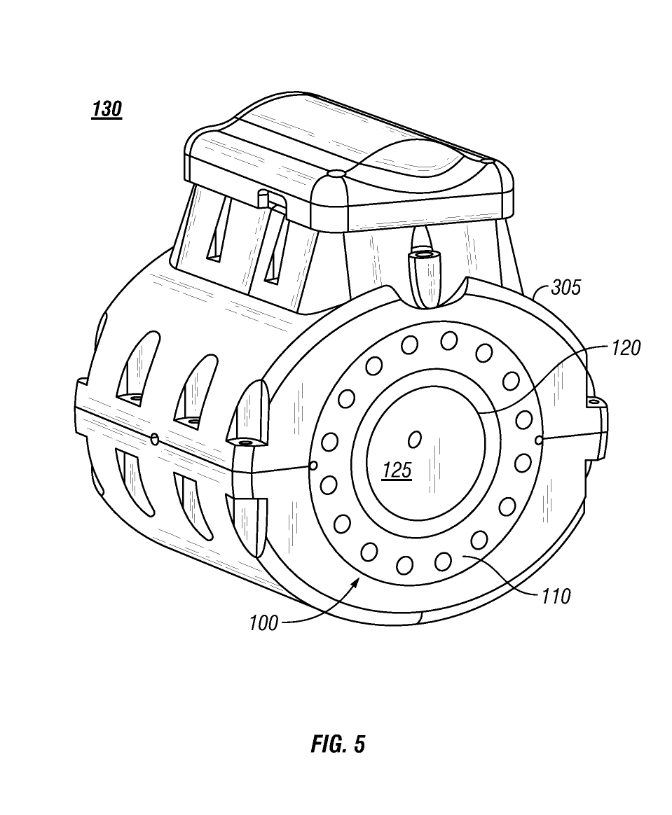

The above-described embodiment of a temperature stabilizing cover encloses the meter spool piece, but not the electronics mounted thereon. In other embodiments, the temperature stabilizing cover may be configured to enclose both. For example, FIG. 5 shows a perspective view of meter 100 disposed within a temperature stabilizing cover 305 in accordance with the principles disclosed herein.

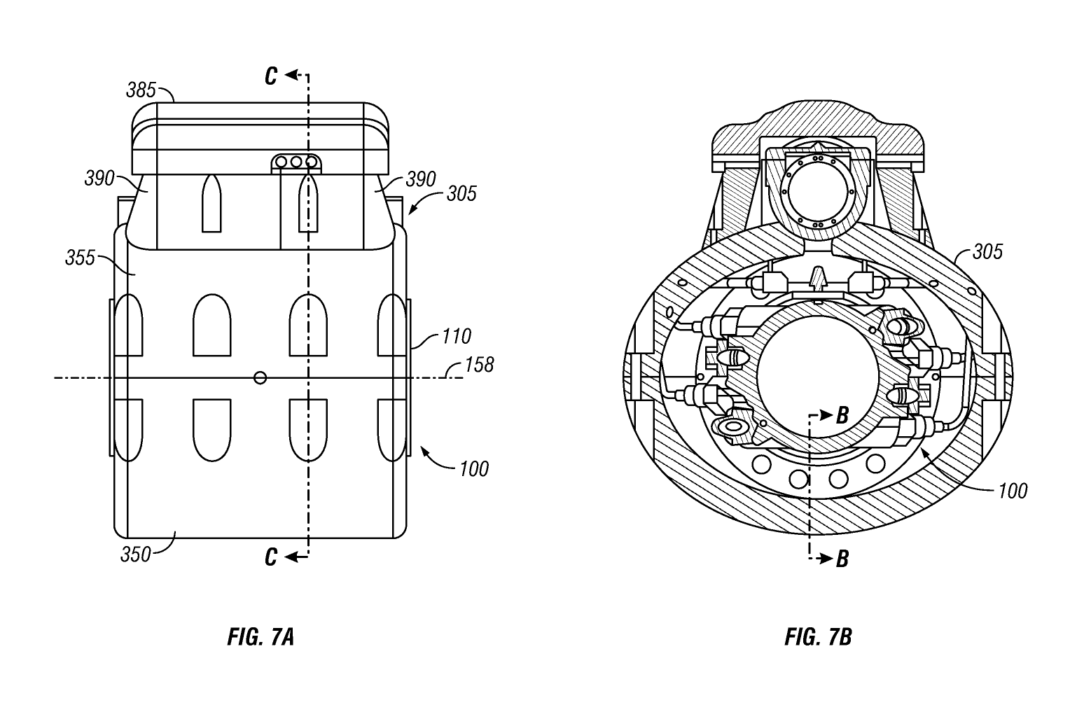

Temperature stabilizing cover 305 extends around the periphery of spool piece 110, leaving open inlet 118 and outlet 120 to allow product to pass through meter 100 within flowbore 125. Further, cover 305 is supported by spool piece 110, and essentially suspends from spool piece 110, as best viewed in FIG. 7B. Similar to cover 105 previously described, cover 305 is a multi-layer or composite structure configured to limit the rate of heat transfer between product passing through meter 100 and the environment 130 external to cover 305.

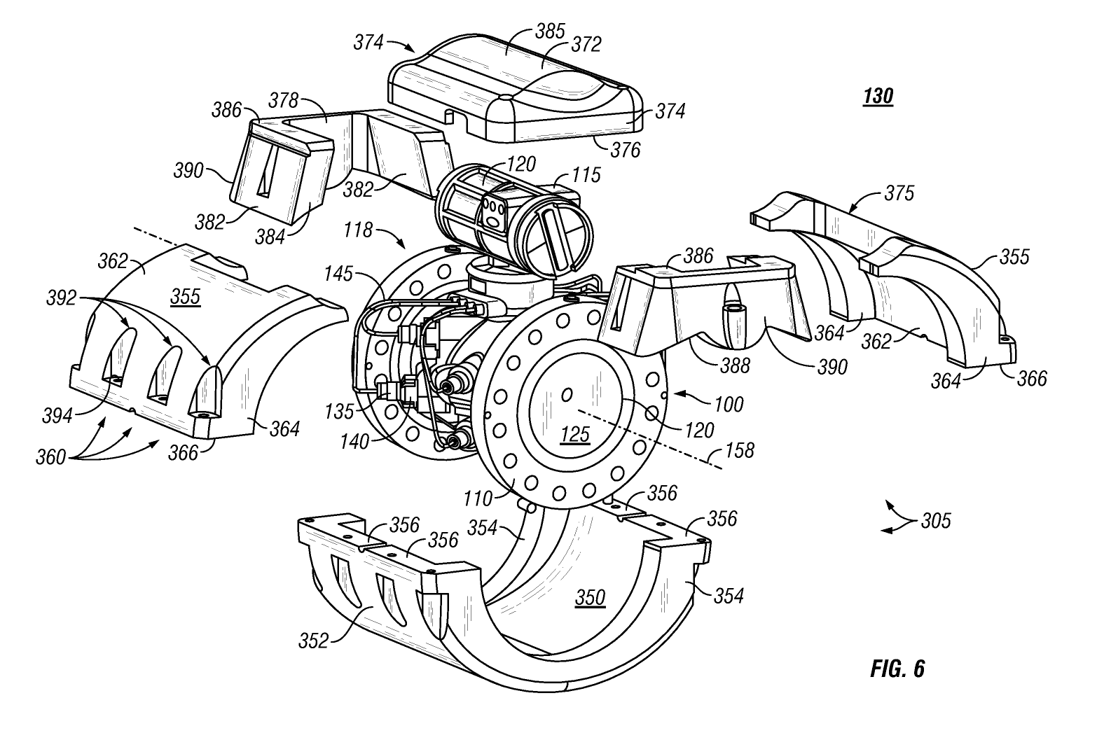

Turning to FIG. 6, an exploded view of temperature stabilizing cover 305 is shown with meter 100 positioned therein. With cover 305 shown disassembled, transducers 135, each disposed within a housing 140 mounted within spool piece 110, are now visible. Further, cables 145, which convey electrical power and carry signals between transducers 135 and electronics 115, are also visible.

In this embodiment, cover 305 includes six separate pieces, a lower half piece 350, two upper quarter pieces 355, two end pieces 390, and a top piece 385. A plurality of fasteners or coupling means 360 are employed to lock pieces 350, 355, 385, 390 together to form a complete cover 305, as shown in FIG. 5. When disengaged, coupling means 360 allow disassembly of cover 305 and separation of each piece 350, 355, 385, 390 from the others 350, 355, 385, 390, as shown in FIG. 6. Each of pieces 350, 355, 385, 390 have a predetermined shape before fastening by coupling means 360 and generally retain that shape once locked together. That is, cover pieces 350, 355, 385, 390 are generally rigid enough such that their shape does not change upon being connected or coupled together to form complete cover 305. Although cover 305 is formed from seven pieces 350, 355, 385, 390 in this embodiment, cover 305 may in other embodiments include fewer or more pieces, all of which, when assembled, form a similar enclosure about spool piece 110.

Lower half piece 350 includes a central portion 352 extending between two semicircular ends or rim portions 354. Collectively, portion 352 and portions 354 terminate in a substantially planar flange 356. Ends 354 extend substantially 180° around spool piece 110 and its longitudinal axis 158. In this maimer, lower half piece 350 may be said to half-circumscribe spool piece 110.

Similarly each of upper quarter pieces 355 includes a central portion 362 disposed between two curved rims or end portions 364. End portions 364 extend substantially 90° about spool piece 110 and longitudinal axis 158. Collectively, central portion 362 and ends 364 terminate to form a generally planar flange 366. Each of pieces 355 further include a semi-rectangular opening 375 formed therein.

When assembled about spool piece 100 to form cover 305, flange 356 of lower half piece 350 mates with and is attached to flanges 366 of upper quarter pieces 355 by coupling means 360. Openings 375 receive electronics 115 to allow cover 305 to enclose spool piece 110 but not electronics 115. As is shown and will be described below, electronics 115 is instead enclosed by top piece 385 and end pieces 390 when coupled to upper quarter pieces 355.

Top piece 385 includes a central portion 372 extending between two substantially rectangular ends 374. Collectively, portion 352 and portions 354 terminate in a generally planar flange 376. Similarly, each of end pieces 390 includes a central portion 378 disposed between two straight side portions 382. Each side portion 382 has a substantially vertically-oriented face 384. Collectively, central portion 378 and side portions 382 terminate to form an upper, generally planar edge 386 and a lower curved edge 388.

When assembled over electronics 115 to complete cover 305, as shown in FIG. 5, each face 384 on one side portion 382 mates with one face 384 on the other side portion 382. Also, planar flange 376 of top piece 385 mates with and is attached to planar edges 386 of end pieces 390 by coupling means 360. Similarly, curved edge 388 of each end piece 390 mates with and is attached to the outer surface of one upper quarter piece 355 by coupling means 360. With top piece 385 and end pieces 390 coupled over electronics 115 to upper quarter pieces 355, cover 305 is complete and encloses both spool piece 110 and electronics 115.

In the embodiment shown, the outer surfaces of pieces 350, 355 include partial or counter bores 392 forming seats 394. Coupling means 360 are positioned on seats 374 to couple upper quarter pieces 355 to lower half piece 350. In some embodiments, including that illustrated by FIGS. 5 through 7B, coupling means 360 includes a bolt (not shown) insertable through each pair of aligned bores 392 and a nut (also not shown) which threadably engages each bolt. In other embodiments, coupling means 360 may include a releasable latch, spring clips, or other fasteners. End pieces 390 are coupled to quarter pieces 355 by a plurality of fasteners, such as but not limited to threaded bolts and/or screws, each secured by a nut. Top piece 385 may be coupled by similar means to end pieces 390. Alternatively, each end piece 390 may include a lip formed along planar edge 386 which snaps into a groove formed in planar flange 376 to fasten these components 385, 390 together.

When pieces 350, 355, 385, 390 are assembled about meter 100, as shown in FIG. 5, cover 305, unlike cover 105 described above, encloses both spool piece 110 and electronics 115. Although cover 305 is formed from six pieces 350, 355, 385, 390 in this embodiment, cover 305 may in other embodiments include fewer or more pieces, all of which, when assembled, form a similar enclosure about meter 100. Aside from having six separate pieces 350, 355, 385, 390 and enclosing electronics 115, cover 305 is substantially similar in function and design to cover 105, described above with reference to FIGS. 1-4.

FIG. 7A shows a side, elevation view of pieces 350, 355, 385, 390 of cover 305 assembled and locked about meter 100. A Section C-C through cover 105 and meter 100 is identified in FIG. 7A and illustrated in FIG. 7B. As best shown in FIG. 7B, cover 305 forms a chamber that is generally elliptical in shape when viewed in cross-section and normal to spool axis 158. For the sake of simplicity, the composite or multi-layered nature of cover 305 is not fully illustrated in FIG. 7B. However, cover 305 is a multi-layer structure having the same individual layers described above in reference to cover 105 and illustrated by FIG. 4. Thus, the methodology described above in conjunction with FIG. 4 may be used to define a specific design configuration for cover 305 which will provide temperature stabilization for meter 100 as a function of given product and environmental temperatures, T_{product}, T_{amb} and T_{rad}, respectively.

During assembly, transducers 135 disposed within their respective housings 140 are mounted within spool piece 110 and coupled via cables 145 to electronics 115. Next, a temperature stabilizing cover in accordance with the principles disclosed herein, such as cover 105 or cover 305, is assembled about meter 100. Upon completion of assembly, meter 100 with the temperature stabilizing cover coupled thereabout is transported to and installed in the field.

During operation of meter 100, the temperature stabilizing cover maintains the difference in temperature of the outer surface of the temperature stabilizing cover and the inner surface of spool piece 100 within a prescribed limit, e.g., 100° F. By maintaining the temperature difference across the cover and meter 100 to within predetermined limits, shifting of transducers 135 relative to spool piece 10 in response to temperature change is reduced. Consequently, signals transmitted from transducers 135 to electronics 115 for determining the product flow rate through meter 100 need not be combined with a correction factor to account for such shifting. Reducing temperature changes experienced by meter 100 by enclosing at least a portion of meter 100 within the temperature stabilizing cover and eliminating the need for use of a correction factor during flow rate calculations reduces inaccuracy and uncertainty in those calculations, thereby yielding a more accurate and reliable estimate of product flow through meter 100.

In the event that meter 100 requires servicing in the field, the temperature stabilizing cover is disassembled from meter 100. Components of meter 100 may then be repaired and/or replaced, as needed. When the maintenance operations are complete, the temperature stabilizing cover is then reassembled about meter 100, and meter 100 stored to operation.

While certain embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

What is claimed is:

1. A cover for a flow meter comprising:
a plurality of cover components fastened together, wherein said cover components have a predetermined shape before being fastened together and generally retain that predetermined shape upon being fastened together, and wherein said cover components include a plurality of material layers having different thermal properties.

2. The cover of claim 1, wherein one or more of the plurality of material layers is a radiant barrier.

3. The cover of claim 2, wherein the radiant barrier comprises mylar.

4. The cover of claim 2, wherein one of the plurality of material layers is an insulation layer disposed between two radiant barriers.

5. The temperature stabilizing cover of claim 4, wherein the two radiant barriers each have a reflectivity in a range of 0.7 to 0.9.

6. The cover of claim 4, wherein one of the plurality of material layers is an outer shell having a rigidity exceeding that of the insulation layer and that of the two radiant barriers.

7. The cover of claim 6, wherein the outer shell is plastic.

8. The cover of claim 6, wherein one of the plurality of material layers is an inner shell and wherein the outer shell, tie insulation layer, the two radiant barriers, and the inner shell form a composite structure configured to maintain a predetermined temperature difference below a maximum limit.

9. The cover of claim 8, wherein the inner shell and the outer shell are substantially impermeable to moisture.

10. A flow meter comprising:
a spool member having a throughbore for fluids to pass therethrough;
one or more transducers extending into the throughbore; and
a cover disposed about the spool member and the one or more transducers, the cover comprising:
a plurality of cover pieces fastened together, the cover pieces being formed of layers including:
an insulation layer;
a first radiant barrier; and
an outer shell including a material having a rigidity greater than the rigidity of the insulation layer and greater than the rigidity of the first radiant barrier.

11. The flow meter of claim 10, wherein the cover pieces are formed of layers further including a second radiant barrier.

12. The flow meter of claim 11, wherein at least one of the first and second radiant barriers comprises Mylar.

13. The flow meter of claim 11, wherein at least one of the first and second radiant barriers has a reflectivity in a range of 0.7 to 0.90.

14. The flow meter of claim 11, wherein the insulation layer is disposed between the first and second radiant barriers.

15. The flow meter of claim 11, wherein the cover pieces are formed of layers further including an inner shell, wherein the insulation layer, the first radiant barrier, and the second radiant barrier are disposed between the outer shell and the inner shell.

16. The flow meter of claim 15, wherein at least one of the outer shell and the inner shell is substantially impermeable to moisture.

17. The flow meter of claim 10, wherein the cover forms a chamber about the spool member, wherein a cross-section of the chamber normal to a longitudinal axis through the spool member is elliptical in shape.

18. The flow meter of claim 17, wherein the spool member has a predetermined outer diameter measured in a first direction normal to the longitudinal axis and wherein the chamber has a dimension measured in the first direction that is generally the same as the spool member outer diameter and has a dimension taken in a second direction that is substantially larger than the spool outer diameter.

19. The flow meter of claim 10, wherein one of the cover pieces is connected to at least one of the other cover pieces by threaded fasteners.

20. The flow meter of claim 10, wherein the cover pieces include generally planar flange portions that engage one another when the cover portions are fastened together.

21. The flow meter of claim 10, wherein the spool member comprises two end flanges and at least one of the cover pieces has an end portion that engages an outer surface of one of the flanges of the spool member.

22. The flow meter of claim 10, wherein a difference between a temperature of an inner surface of the flow meter surrounding the throughbore and a temperature of an outer surface of the outer shell is at or below a predetermined limit.

23. The flow meter of claim 10, wherein a difference between a temperature of fluid passing through the spool member and an effective environmental temperature dependent upon surrounding ambient and radiant temperatures is at or below a predetermined limit.

24. The flow meter of claim 23, wherein the predetermined limit is 100° F.

25. A method for temperature stabilization of a flow meter exposed to an environment characterized by transient thermal conditions, the method comprising:
disposing a layer of insulation around at least a portion of the flow meter;
positioning a first radiant barrier radially outward of the insulation layer to reduce radiative heat transfer from the environment to the insulation layer;
positioning a second radiant barrier radially inward of the insulation layer to reduce radiative heat transfer from the flow meter to the insulation layer;
enclosing the first radiant barrier, the insulation layer, and the second radiant barrier between an outer shell and an inner shell to form a cover; and
maintaining a defined temperature difference through a spool piece of the flow meter and the cover below a maximum limit.

26. The method of claim 25, further comprising providing the outer shell and the inner shell, both being substantially impermeable to moisture.

27. The method of claim 25, further providing the first and second radiant barriers, each having a reflectivity in a range of 0.7 to 0.90.
